(19) United States
(12) Patent Application Publication
(10) Pub. No.: US 2004/0051637 A1
(43) Pub. Date: Mar. 18, 2004

(54) Exchanging remote data in a wireless telecommunication system

(76) Inventor: C. Terry Vance, Atlanta, GA (US)

Correspondence Address: CINGULAR WIRELESS, 5565 GLENRIDGE CONNECTOR, 9TH FLOOR MC 920, C/O LINDA GILES, SYSTEM ANALYST, ATLANTA, GA, 30342, US

(21) Appl. No.: 10/244,166

(22) Filed: Sep. 13, 2002

(51) Int. Cl. G08B 1/08

(52) U.S. Cl. 340/539.11

(57) ABSTRACT

Exchanging remote data in a wireless telecommunication system comprises updating a database with first data collected remotely, the first data comprising information corresponding to the availability of a system operator, and operating the wireless telecommunication system using the database.

### DESCRIPTION OF THE INVENTION

1. Field of the Invention

The invention relates generally to systems and methods for exchanging remote data, and more particularly, to systems and methods for exchanging remote data in a wireless telecommunication system.

2. Background of the Invention

The use of telephone products and systems in the day-to-day lives of most people is continually growing. With the advent and steady growth of wireless telecommunications, wireless telecommunication systems will increasingly be utilized for not only voice data, but also for sending and receiving packetized data for use on the Internet, for example. In an effort to lower operating costs, increase system availability, and increase value for its subscribers, wireless telecommunications providers wish to exchange remote data at least between the network operation center and system operators working in the field. Wireless telecommunication providers realize a time and a cost savings by exchanging remote data.

Therefore, the need to efficiently exchange remote data in wireless telecommunication systems has become a common need for many wireless telecommunication providers. More specifically, exchanging remote data at least between the network operation center and system operators working in the field has become a critical service for many wireless telecommunication providers. This is because in an increasingly competitive environment, meeting and exceeding the expectations of subscribers or others who receive services is essential for a wireless telecommunication provider.

One solution to the exchanging remote data problem is for a system operator working in the field to call a network operation center operator directly and relay any given information verbally. For example, the system operator in the field, using conventional methods, may call the network operations center operator via a publicly switched telephone network or a two-way radio system. Upon making contact with the network operation center operator, the system operator may state that he is going on vacation and therefore should not be assigned trouble tickets, request directions or a lock combination to a site on the wireless telecommunications system, or manifest an intention to enter a site. Great inefficiencies are created in this procedure because, for example, the volume of calls going into the network operations center operator for general procedural matters as discussed above for example, needlessly consumes a significant portion of the network operations center operator's time. In addition, this conventional solution does not conveniently allow for the archiving and analysis of the data received. Accordingly, efficiently exchanging remote data in wireless telecommunication systems remains an elusive goal.

Thus, there remains a need for efficiently exchanging remote data on wireless telecommunication systems. In addition, there remains a need for exchanging remote data at least between the network operation center and system operators working in the field.

### SUMMARY OF THE INVENTION

Consistent with the present invention, methods and systems for exchanging remote data in a wireless telecommunication system are provided that avoid problems associated with prior methods and systems for exchanging remote data in a wireless telecommunication system as discussed herein above.

In one aspect, an improved method for exchanging remote data in a wireless telecommunication system comprises updating a database with first data collected remotely, the first data comprising information corresponding to the availability of a system operator, and operating the wireless telecommunication system using the database.

In another aspect, an improved system for exchanging remote data in a wireless telecommunication system comprises a component for updating a database with first data collected remotely, the first data comprising information corresponding to the availability of a system operator, and a component for operating the wireless telecommunication system using the database.

In yet another aspect, a computer-readable medium on which is stored a set of instructions for exchanging remote data in a wireless telecommunication system, which when executed perform stages comprising updating a database with first data collected remotely, the first data comprising information corresponding to the availability of a system operator, and operating the wireless telecommunication system using the database.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a functional block diagram of an exemplary system for exchanging remote data in a wireless telecommunication system consistent with an embodiment of the present invention;

FIG. 2 is a flow chart of an exemplary method for exchanging remote data in a wireless telecommunication system consistent with an embodiment of the present invention;

FIG. 3 is a flow chart of an exemplary subroutine used in the exemplary method of FIG. 2 for maintaining records in the database including records corresponding to at least one of the system operator and a site located in the wireless telecommunication system consistent with an embodiment of the present invention;

FIG. 4 is a flow chart of an exemplary subroutine used in the exemplary method of FIG. 2 for updating a database with first data collected remotely, the first data comprising information corresponding to the availability of a system operator consistent with an embodiment of the present invention;

FIG. 5 is a flow chart of an exemplary subroutine used in the exemplary subroutine of FIG. 4 for authenticating the system operator consistent with an embodiment of the present invention; and

FIG. 6 is a flow chart of an exemplary subroutine used in the exemplary method of FIG. 2 for operating the wireless telecommunication system using the database consistent with an embodiment of the present invention.

### DESCRIPTION OF THE EMBODIMENTS

Reference will now be made to various embodiments according to this invention, examples of which are shown in the accompanying drawings and will be obvious from the description of the invention. In the drawings, the same reference numbers represent the same or similar elements in the different drawings whenever possible.

System For Exchanging Remote Data In A Wireless Telecommunication System

Consistent with the general principles of the present invention, an improved system for exchanging remote data in a wireless telecommunication system, comprises a component for updating a database with first data collected remotely, the first data comprising information corresponding to the availability of a system operator, and a component for operating the wireless telecommunication system using the database.

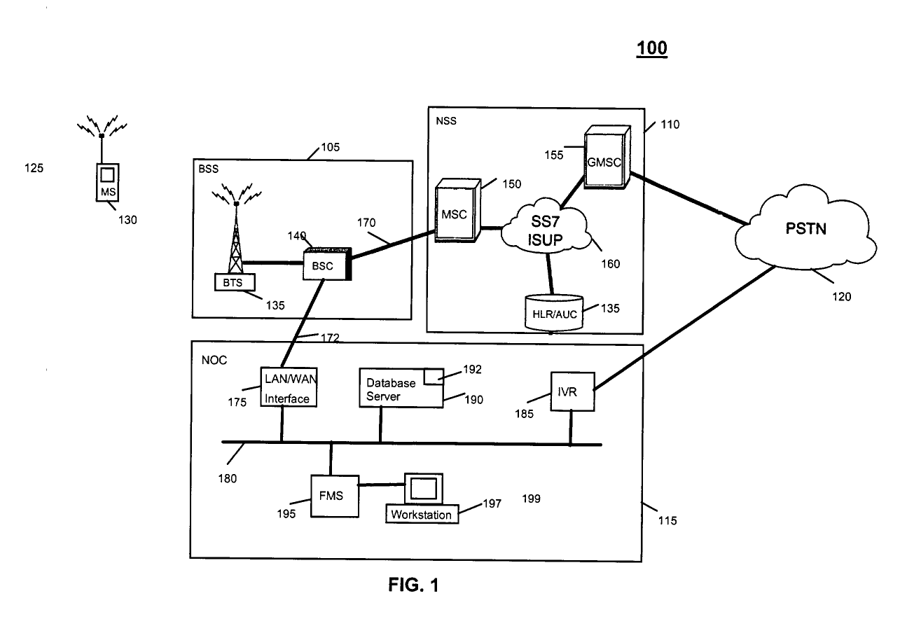

As shown in FIG. 1, a system for exchanging remote data in a wireless telecommunication system 100 may comprise a base station subsystem (BSS) 105, a network and switching subsystem (NSS) 110, a network operation center (NOC) 115, a mobile station (MS) 130, and a publicly switched telephone network (PSTN) 120. The elements of system 100 will be described in greater detail below. Consistent with an embodiment of the invention, the component for updating the database may comprise a database server 190 (as described below), the component for operating the wireless telecommunication system may comprise a fault management system 195 or a workstation 197; the system operator may comprise a system operator 125; and, the database may comprise a database 192 residing on database server 190 (as described below). First data may comprise any data remotely received from system operator 125. Those of ordinary skill in the art, however, will appreciate that other elements of system 100 may comprise the component for updating the database, the component for operating the wireless telecommunication system, the system operator, and the database.

System 100 may utilize GSH technology enhanced with GPRS in embodiments of the present invention. Those of ordinary skill in the art will appreciate, however, that other wireless telecommunication technologies standards may be employed, for example, FDMA, TDMA, CDMA, UMTS, CDMA2000, and EDGE, without departing from the spirit of the invention.

Wireless telecommunications may include radio transmission via the airwaves, however, those of ordinary skill in the art will appreciate that various other telecommunication techniques can be used to provide wireless transmission including infrared line of sight, cellular, microwave, satellite, blue-tooth packet radio, and spread spectrum radio. Wireless data may include, but is not limited to, paging, text messaging, e-mail, Internet access, instant messaging, and other specialized data applications specifically excluding or including voice transmission.

As shown in FIG. 1, BSS 105 may comprise, for example, a base station controller (BSC) 140, and a base transceiver station (BTS) 135. BSS 105 connects to MS 130 through a radio interface and connects to NSS 115 through an interface 170. BSC 140 controls BTS 135 and may control a plurality of other base transceiver stations in addition to BTS 135. BTS 135 may comprise radio transmission and reception equipment located at an antenna site.

Interface 170 between NSS 110 and BSS 105, and a wide area network 172 between BSC 140 and NOC 115, may comprise T-1 lines using X.25 or TCP/IP protocol, for example.

MS 130 may comprise a mobile phone, a personal computer, a hand-held computing device, a multiprocessor system, microprocessor-based or programmable consumer electronic device, a minicomputer, a mainframe computer, a personal digital assistant (PDA), a facsimile machine, a telephone, a pager, a portable computer, or any other device for receiving and/or transmitting information. MS 130 may utilize cellular telephone protocols such as wireless application protocol (WAP), or blue-tooth protocol. The invention, as disclosed in this embodiment, in its broadest sense is not limited to a particular form of mobile system or communications protocol. Those of ordinary skill in the art will recognize that other systems and components may be utilized within the scope and spirit of the invention.

Still referring to FIG. 1, NSS 110 may comprise a mobile switching center (MSC) 150, a first network 160, a home location register/authentication center (HLR/AUC) 135, and a gateway mobile switching center (GMSC) 155. NSS 110 manages the communication between subscribers, for example, system operator 125 using MS 130, and other telecommunications users, for example, those using publicly switched telephone network (PSTN) 120. PSTN 120 may comprise, for example, the worldwide voice telephone network.

MSC 150 coordinates call set-up to and from subscribers such as system operator 125 using MS 130. MSC 150 may control several base station controllers such as, and similar to BSC 140. GMSC 110 is used to interface with external networks for communication with users outside of the wireless system, such users on PSTN 120.

HLR/AUC 135 may comprise a stand-alone computer without switching capabilities, a database which contains subscriber information, and information related to the subscriber's current location, but not the actual location of the subscriber. The AUC portion of HLR/AUC 135 manages the security data for subscriber authentication. Another sub-division of HLR/AUC 135 may include an equipment identity register (EIR) (not shown) which may store data relating to mobile equipment (ME).

NSS 110 may also include a visitor location register (VLR) (not shown). The VLR links to one or more mobile switching center located on other systems, temporarily storing subscription data of subscribers currently served by MSC 150. The VLR holds more detailed data than HLR/AUC 135. For example, the VLR may hold more current subscriber location information than the location information at HLR/AUC 230.

GMSC 155 is utilized to interface with PSTN 120. In order to set up a requested call, the call is initially routed to GMSC 155, which finds the correct home location register by knowing the director number of the subscriber. GMSC 155 has an interface with an external network, such as PSTN 120, for providing gateway communications.

The elements of NSS 110 are connected using first network 160. First network 160 may comprise an intelligent network utilizing signal system 7 (SS7) in an ISDN user part (ISUP) protocol. ISUP defines the protocol and procedures used to setup, manage, and release trunk circuits that carry voice and data calls over a public switched telephone network. ISUP is used for both ISDN and non-ISDN calls. Calls that originate and terminate at the same switch do not use ISUP signaling.

Still referring to FIG. 1, network operation center (NOC) 115 may comprise a LAN/WAN interface 175, a local area network (LAN) 180, an interactive voice response system (IVR) 185, a database server 190, a database 192, a fault management system (FMS) 195, a workstation 197, and a NOC operator 199.

LAN/WAN interface 175 interfaces WAN 172 and LAN 180, thus connecting the elements connected to LAN 180 with BSC 140. A WAN may comprise a communications network that covers a wide geographic area, such as state or country, whereas a LAN may be contained within a building or complex connecting servers, workstations, a network operating system, and a communications link.

Connected to LAN 180 is IVR 185. An IVR is an automated telephone answering system that responds with a voice menu and allows the user to make choices and enter information via the keypad. IVR systems are widely used in call centers as well as a replacement for human operators and may also integrate database access and fax response. Using a dual-tone multifrequency (DTMF) signal such as those generated by telephone keypads, data may be entered into IVR 185 from a telephone, for example, MS 130 by a DTMF signal passing from MS 130 through BSS 105, NSS 110, PSTN 120, and to IVR 185. From IVR 185, the data may then be pushed onto LAN 180 to database server 190 and stored in database 192 on database server 190. Database server 190 may comprise a personal computer, a hand-held computing device, a multiprocessor system, microprocessor-based or programmable consumer electronic device, a minicomputer, a mainframe computer, a personal digital assistant (PDA), a facsimile machine, a telephone, a pager, a portable computer, or any other device for receiving and/or transmitting information.

FMS 195 is a device used to detect, diagnose, and correct problems on system 100 effecting the security or reliability of system 100. Like database server 190, FMS 195 may comprise a personal computer, a hand-held computing device, a multiprocessor system, microprocessor-based or programmable consumer electronic device, a minicomputer, a mainframe computer, a personal digital assistant (PDA), a facsimile machine, a telephone, a pager, a portable computer, or any other device for receiving and/or transmitting information. Workstation 197 allows NOC operator 199 to interface with FMS 195. Workstation 197 may comprise, for example, a scalable performance architecture (SPARC) station marketed by SUN Microsystems, Inc. of 901 San Antonio Road Palo Alto, Calif. 94303-4900.

Method For Exchanging Remote Data In A Wireless Telecommunication System

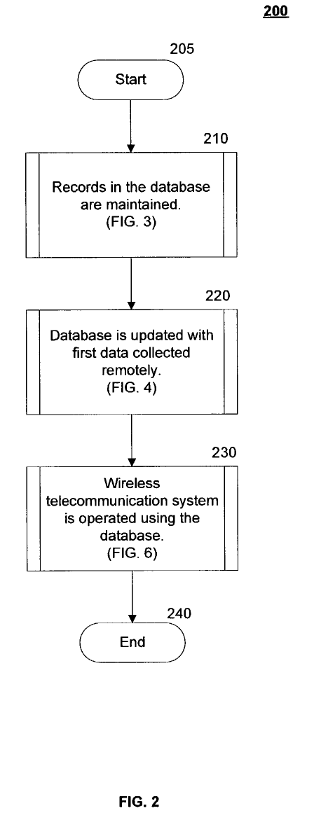

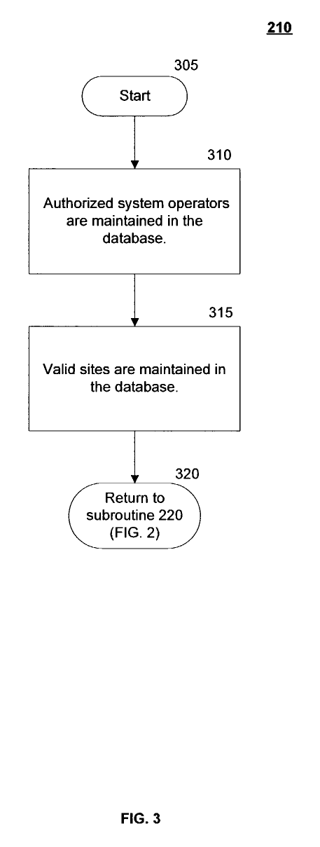

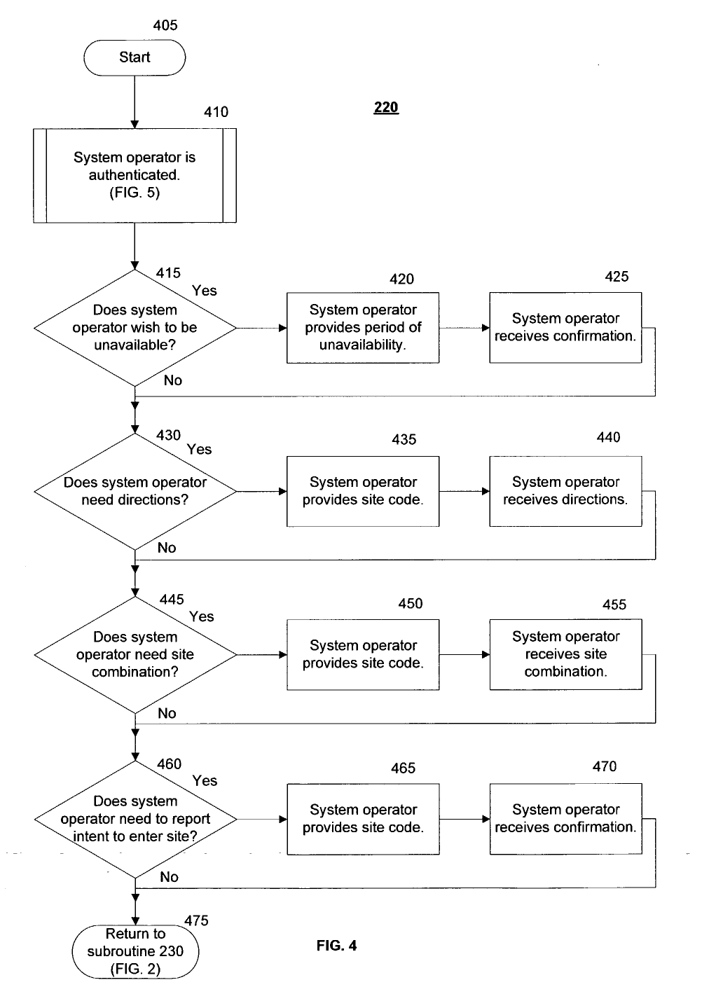

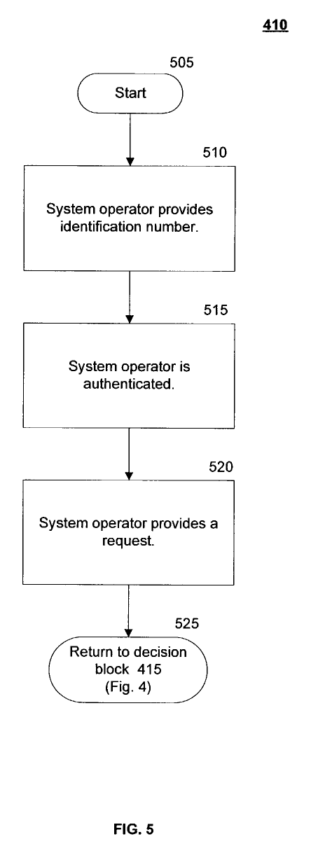

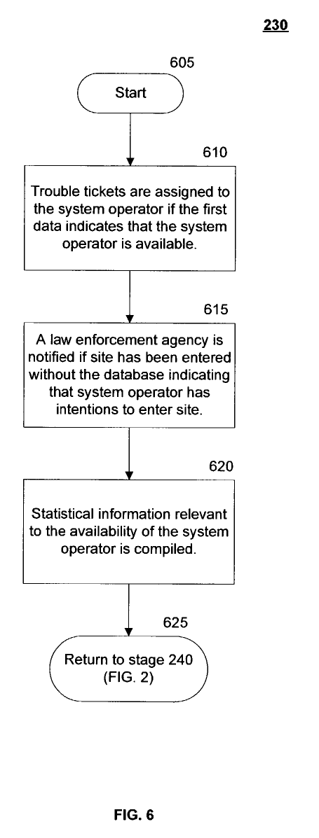

FIG. 2 is a flow chart setting forth the general stages involved in exemplary method for exchanging remote data in a wireless telecommunication system consistent with an embodiment of the present invention. The implementation of the stages of exemplary method 200 in accordance with an exemplary embodiment of the present invention will be described in greater detail in FIG. 3 through FIG. 6. Exemplary method 200 begins at starting block 205 and proceeds to exemplary subroutine 210 where records in database 192 are maintained. The stages of exemplary subroutine 210 are shown in FIG. 3 and will be described in greater detail below. From exemplary subroutine 210 where records in database 192 are maintained, exemplary method 200 continues to exemplary subroutine 220 where database 192 is updated with first data collected remotely. The stages of exemplary subroutine 220 are shown in FIG. 4 and FIG. 5 and will be described in greater detail below. Once database 192 is updated with first data collected remotely in exemplary subroutine 220, exemplary method 200 advances to exemplary subroutine 230 where wireless telecommunication system 100 is operated using database 192. The stages of exemplary subroutine 230 are shown in FIG. 6 and will be described in greater detail below. From exemplary subroutine 230, exemplary method 200 ends at stage 240.

Maintaining Records In The Database

FIG. 3 describes exemplary subroutine 210 from FIG. 2 for maintaining records in database 192 including records corresponding to at least one of system operator 125 and a site located in wireless telecommunication system 100 consistent with an embodiment of the present invention. Exemplary subroutine 210 begins at starting block 305 and advances to stage 310 where authorized system operators are maintained in database 192. For example, system operators may comprise engineers, technicians, skilled laborers, or vendor. Those of ordinary skill in the art, however, will appreciate that other designations of persons capable of effecting repair, operations, or maintenance of system 100 my comprise system operators. Authorized system operators may comprise those who presently have the authority within the enterprise controlling system 100 to operate or maintain elements comprising system 100. When maintaining the data, for example, a system operator code number corresponding to system operator may be placed in database 192 signifying that system operator 125 has authority to operate on components, elements, and sub-systems of system 100.

From stage 310, where authorized system operators are maintained in database 192, exemplary subroutine 210 advances to stage 315 where valid sites are maintained in database 192. In addition to maintaining records relevant to authorized system operators, records in database 192 also include data associated with valid sites located in wireless telecommunication system 100. For example, if BTS 135 is a valid site in system 100, a record in database 192 would reflect such.

After valid sites are maintained in database 192 in stage 315, exemplary subroutine 210 continues to stage 320 and returns to subroutine 220 of FIG. 2.

Updating A Database With First Data Collected Remotely

FIG. 4 describes exemplary subroutine 220 from FIG. 2 for updating database 192 with first data collected remotely, the first data comprising information corresponding to the availability of system operator 125 consistent with an embodiment of the present invention. Exemplary subroutine 220 begins at starting block 405 and advances to exemplary subroutine 410 where system operator 125 is authenticated. The stages of exemplary subroutine 410 will be described in greater detail below with respect to FIG. 5.

From exemplary subroutine 410 where system operator 125 is authenticated, exemplary subroutine 220 advances to decision block 415 where it is determined if system operator 125 wishes to be unavailable. For example, system operator 125 may use MS 130 to communicate with IVR 185. Once connected with system operator 125 during the authentication procedure of FIG. 5, IVR 185 may query system operator 125, for example, to “press 1 if you wish to make yourself inactive.” In response, using the telephone keypad, system operator 125 may enter a “1” on the DTMF key pad to manifest a desire to be inactive for a period of time.

If it is determined at decision block 415 that system operator 125 wishes to be unavailable, exemplary subroutine 220 advances to stage 420 where system operator 125 provides a period of unavailability. For example, IVR 185 may query system operator to enter the beginning date and time and the ending date and time of the period of unavailability. System operator 125 may input the time period using the DTMF key pad of MS 130.

After system operator provides the period of unavailability in stage 420, exemplary subroutine 220 continues to stage 425 where system operator 125 receives confirmation. For example, IVR 185 may send an audible signal to MS 130 stating the code number of system operator 125 and the time period of unavailability entered. If the code number and time period are correct, system operator 125 may press a key on the keypad of MS 130, confirming the correctness of the information. Upon receiving this correctness indication, IVR 185 may push the unavailability data for system operator 125 onto LAN 180 and to database server 190. Once the unavailability data for system operator 125 is received by database server 190, it may then be stored in database 192. With database 192 having an open architecture, database 192 may be queried by FMS 195 or any other system on LAN 180 with the proper security and ability to read the open architecture of database 192. Open architecture may include software or hardware in which the specifications are made public in order to encourage third-party vendors to develop add-on products. Open architecture may be contrasted with closed architecture whose technical specifications are not made public. For example, IVR 185 may comprise a closed architecture

From stage 425 where system operator 125 receives confirmation, or from decision block 415, if it is determined that system operator 125 does not wish to be unavailable, exemplary subroutine 220 advances to decision block 430 where it is determined if system operator 125 needs directions. For example, IVR 185 may query system operator 125, to “press 2 if you need directions.” In response, using MS 130, system operator 125 may enter a “2” on the DTMF key pad to manifest a desire for directions.

If it is determined at decision block 430 that system operator needs directions, exemplary subroutine 220 advances to stage 435 where system operator provides a site code. For example, once IVR 185 knows that system operator 185 needs direction, the IVR will then ask for the site code of the BTS for which system operator 125 desires direction. System operator 125 may enter the site code using the DTMF key pad of MS 130.

After system operator provides the site code in stage 435, exemplary subroutine 220 continues to stage 440 where system operator 125 receives directions. For example, from data sorted on IVR 185, database server 190, or other systems on LAN 180, IVR 185 may send a audible signal to MS 130 stating the directions corresponding to the site code previously entered.

From stage 440 where system operator 125 receives directions, or from decision block 430, if it is determined that system operator 125 does not need directions, exemplary subroutine 220 advances to decision block 445 where it is determined if system operator 125 needs a site combination. For example, IVR 185 may query system operator 125 to “press 3 if you need a combination.” In response, using MS 130, system operator 125 may enter a “3” on the DTMF key pad to manifest a desire to receive the combination.

If it is determined at decision block 445 that system operator 125 needs a site combination, exemplary subroutine 220 advances to stage 450 where system operator 125 provides the site code. For example, once IVR 185 knows that system operator 125 desires a combination, IVR 185 may then ask for the site code of the BTS for which system operator 125 desires the combination. System operator 125 may enter the site code using the DTMF key pad of MS 130.

After system operator 125 provides the site code in stage 450, exemplary subroutine 220 continues to stage 455 where system operator 125 receives the site combination. For example, from data stored on IVR 185, database server 190, or other systems on LAN 180, IVR 185 may send a audible signal to MS 130 stating the combination corresponding to the site code previously entered.

From stage 455 where system operator 125 receives the site combination, or from decision block 445, if it is determined that system operator 125 does not the need a site combination, exemplary subroutine 220 advances to decision block 460 where it is determined if system operator 125 needs to report an intent to enter a site such as BTS 135. For example, IVR 185 may query system operator 125 to “press 4 if you need to report your intent to enter a site.” In response, using the telephone keypad of MS 130, system operator 125 may enter a “4” on the DTMF key pad to manifest a desire to enter the site.

If it is determined at decision block 460 that system operator 125 needs to report intent to a enter site, exemplary subroutine 220 advances to stage 465 where system operator 125 provides a site code. For example, once IVR 185 knows that system operator 185 needs to report the intent to enter the site, IVR 185 may then ask for the site code, for example, of the BTS for which system operator 125 desires to enter. System operator 125 may enter the site code using the DTMF key pad of MS 130.

After system operator 125 provides the site code in stage 465, exemplary subroutine 220 continues to stage 470 where system operator 125 receives confirmation. For example, IVR 185 may send an audible signal to MS 130 stating the code number of the site to be entered. If the code number is correct, system operator 125 may press a key on the keypad of MS 130, confirming the correctness of the information. Upon receiving this correctness indication, IVR 185 may push the site entry data for system operator 125 onto LAN 180 to database server 190. Once the site entry data for system operator 125 is received by database server 190, it may then be stored in database 192. With database 192 having an open architecture, database 192 may be queried by FMS 195 or any other system on LAN 180 with the proper security and ability to read the open architecture of database 192.

Once the site is entered by system operator 125 and this site entry is detected by FMS 195, a site record containing an entry time stamp, the site code, and system operators identification number may be entered in database 192. This site entry record may be used by NOC operator 199 in detecting unauthorized entry into the site as described below with respect to stage 615 of FIG. 6.

From stage 470 where system operator 125 receives confirmation, or from decision block 460, if it is determined that system operator 125 does not need to report intent to the enter site, exemplary subroutine 220 advances to stage 475 and returns to subroutine 230 of FIG. 2.

Authenticating the System Operator

FIG. 5 describes exemplary subroutine 410 from FIG. 4 for authenticating system operator 15 consistent with an embodiment of the present invention. Exemplary subroutine 410 begins at starting block 505 and advances to stage 510 where system operator 125 provides a system operator identification code. For example, system operator 125 may use MS 130 to call IVR 185. Once connected, IVR 185 may query system operator 125 for the system operator identification code. Using the telephone keypad, system operator 125 may enter a series of DTMF tones representing the system operator identification code unique to system operator 125.

From stage 510 where system operator 125 provides the system operator identification code, exemplary subroutine 410 advances to stage 515 where system operator 125 is authenticated. For example, IVR 185 may take the system operator identification code received in stage 510 and push it onto LAN 180 to database server 190. Database server 190 may then look-up the system operator identification code in database 192, to determine if it is valid. If the system operator identification code is valid, system operator 125 is authenticated. Those skilled in the art will appreciate that system operator may be authenticated in many different ways.

Once system operator 125 is authenticated in stage 515, subroutine 410 advances to stage 520 where system operator 125 provides a request. A request, for example may comprise a request for system operator to provide a time period in which system operator 125 will be unavailable, a request for directions to a site, a request for a combination to a lock on a site, or an intent of system operator 125 to enter a site. Those skilled in the are will appreciate that the aforementioned requests are exemplary and that many other types of requests may be employed.

After system operator provides a request in stage 520, exemplary subroutine 410 continues to stage 525 and returns to decision block 415 of FIG. 4.

Operating the Wireless Telecommunication System

FIG. 6 describes exemplary subroutine 230 from FIG. 2 for operating wireless telecommunication system 100 using database 192 consistent with an embodiment of the present invention. Exemplary subroutine 230 begins at starting block 605 and advances to stage 610 where trouble tickets are assigned to system operator 125 if the first data indicates that system operator 125 is available. For example, if system operator 125 intends to go on vacation for one week and has been made inactive in database 192 for a time period corresponding to the vacation period, FMS 195 may not assign a trouble ticket to system operator 125. Specifically, if for example, FMS 195 detects a problem with BTS 135, a site assigned to system operator 125, the trouble ticket corresponding to this problem would normally as a matter of course be assigned to system operator 125. However, because system operator has been made inactive, the trouble ticket will go to an alternative system operator assigned to back-up system operator 125.

Continuing with the-example, FMS 195 may make system operator 125 active automatically at the end of the pre-designated vacation time period. Or, as an alternative, FMS 195 may keep system operator 125 inactive until system operator 125 positively indicates a desire to become active once again. This positive desire to become active once again may be communicated to FMS 195 in a manner similar to process of making system operator 125 unavailable as described above, with system operator 125 indicated a desire to be active rather than inactive. Moreover, if FMS determines that system operator 125 should be active, FMS 195 may attempt to communicate this to system operator 125. For example, the time period for system operator's vacation may have expired, but system operator 125 may not have been made active. FMS 195 may then send a communications to system operator 125 asking system operator 125 to extend the inactive time period or switch to active status. This communications may be made via e-mail, voice mail, IVR 185, facsimile, pager, or by any other process or procedure known by those of ordinary skill in the art.

From stage 610 where trouble tickets are assigned to system operator 125 if the first data indicates that system operator 125 is available, exemplary subroutine 230 advances to stage 615 where a law enforcement agency is notified if a site has been entered without database 192 indicating that system operator has intentions to enter the site. For example, BTS 135 may be equipped with an entry alarm system that may automatically notify NOC operator 199 that entry has been made at BTS 135. Specifically, the entry alarm may be first reported to FMS 195. FMS 195 may then query database 192 on database server 190 to determine if any system operators have manifested an intention to enter BTS 135. If so, FMS 195 may report the entry alarm along with the identity of the system operator who manifested an intention to enter BTS 135, if any, to NOC operator 199 through workstation 197. If FMS 195 has associated a system operator, for example system operator 125, with the entry alarm, NOC operator may attempt to contact system operator 125 to determine if system operator in fact caused the entry alarm. If system operator indicates that he did not cause the entry alarm, or if FMS 195 does not find a record in database 192 associating a system operator with the entry alarm, NOC operator 199 may notify a law enforcement agency with a degree of confidence that a trespass or other crime may be in progress at BTS 135.

Once a law enforcement agency is notified if a site has been entered without database 192 indicating that system operator 125 has intentions to enter the site in stage 615, subroutine 230 advances to stage 620 where statistical information relevant to the availability of system operator 125 is compiled. For example, if system operator 125 reported, on a time sheet, 2 hours worked at BTS 135 and three hours worked at a second BTS, a manager of system operator may reconcile the time sheet with data from database 192. Specifically, if database 192 indicates that system operator 125 entered BTS 135 at 9:00 AM and entered the second BTS at 12:00 PM, and that the two BTSs are one hour apart, the manager has good reason to believe the timesheet is substantially correct, for example. However, if database 192 indicates the second BTS was entered at 10:30 AM, this may give the manager reason to believe the timesheet may be incorrect. Those of ordinary skill in the art will appreciate that the data in database 192 may be used for many other purposes in gaining statistical information.

After statistical information relevant to the availability of system operator 125 is compiled in stage 620, exemplary subroutine 230 continues to stage 625 and returns to stage 240 of FIG. 2.

Multi-Format Procedure Engine

A multi-format procedure engine allows a system operator or technical writer to enter procedure documentation or notes into pre-formatted text fields, and then have database server 190 create and published procedures.

Database server 190 may store text in database 192 and create various different formats of a technical procedure, then publish the formats to directories of storage space on database server 190. For example, if system operator 125 wishes to create a technical procedure on how to restart a particular system of BSS 105, system operator 125 would enter, through a GUI interface to a program-executed on database server 190, a title of the procedure, a brief synopsis of the procedure, and a body of the procedure. System operator 125 would then have the option of life cycles for the document. The procedure would remain in the “draft” state until system operator 125 is ready to have it proof-read or edited by a manager or peer, for example. When the procedure is complete, approved by the manager or peer, and ready for submission, the procedure is placed into a “publish” state. At this time, database server 190 may create various different formats of the same document for easy access by different means. It may create an HTML version and place it in a directory so that the procedure would be viewable on an intranet. It may create a Microsoft Word version of the procedure and place it in a shared directory for PC access, or for burning onto a CDROM. It may also create a plain text file and place it in a UNIX directory so that system operators could reach it by a command line login or from a UNIX prompt. An advantage of the multi-format procedure engine is to make as many useful versions of the same procedure available in whatever formats are most easily used by the system operators or other users. Any time the procedure is updated, all the different versions of it are updated automatically. Due to this, there is one master procedure and all formats of the same procedure are substantially identical in content.

The multi-format procedure engine addresses a need for consistent documentation with easy authoring utilities. System operators are not typically strong at documenting work and may not have time to spend on writing properly formatted technical procedures. This engine gives system operators an easy to use GUI for procedure submission into database 192, with database server 190 doing the rest of the work in formatting the document and publishing it in directories. The multi-format procedure engine also addresses the concerns of having different versions of the same procedure, for example, one in Microsoft Word, one in plain text, one on a CDROM, one on the intranet/internet, and one in a UNIX format, yet not knowing which is the most accurate or up-to-date.

It will be appreciated that a system in accordance with an embodiment of the invention can be constructed in whole or in part from special purpose hardware or a general purpose computer system, or any combination thereof. Any portion of such a system may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements (not shown) which may be connected directly to the system or which may transfer the information to the system over a network or other mechanism for transferring information in a conventional manner.

The foregoing description has been limited to a specific embodiment of this invention. It will be apparent, however, that various variations and modifications may be made to the invention, with the attainment of some or all of the advantages of the invention. It is the object of the appended claims to cover these and such other variations and modifications as come within the true spirit and scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An improved method for exchanging remote data in a wireless telecommunication system, comprising:
updating a database with first data collected remotely, the first data comprising information corresponding to the availability of a system operator; and
operating the wireless telecommunication system using the database.

2. The method of claim 1, wherein the first data is collected remotely from a system operator.

3. The method of claim 1, wherein the first data is collected using an interactive voice response system (IVR).

4. The method of claim 1, wherein operating the wireless telecommunication system further comprises assigning trouble tickets to the system operator if the first data indicates that the system operator is available.

5. The method of claim 1, wherein operating the wireless telecommunication system further comprises notifying a law enforcement agency if a site on the wireless telecommunication system has been entered without the database indicating that the system operator has intentions to enter the site.

6. The method of claim 1, wherein operating the wireless telecommunication system further comprises compiling statistical information relevant to the availability of the system operator.

7. The method of claim 1, further comprising maintaining records in the database including records corresponding to at least one of the system operator and a site located in the wireless telecommunication system.

8. The method of claim 7, wherein records corresponding to the system operator include whether the system operator is authorized to operate in the wireless telecommunication system.

9. The method of claim 7, wherein records corresponding to the site located in wireless telecommunication system include whether the site is a valid site in the wireless telecommunication system.

10. The method of claim 1, further comprising updating the database with second data collected remotely, the second data comprising information corresponding to the system operator's intention to enter a site.

11. The method of claim 10, wherein the second data is collected remotely from the system operator.

12. The method of claim 10, wherein the second data is collected remotely using an interactive voice response system (IVR).

13. The method of claim 10, wherein the second data comprises a code number for the site.

14. The method of claim 10, wherein the second data is provided to a network operations center (NOC).

15. The method of claim 1, further comprising providing information remotely, the information corresponding to at least one of directions to a site in the wireless telecommunication system and a combination to a lock located on the site in the wireless telecommunication system.

16. The method of claim 15, wherein the information is provided remotely to the system operator.

17. The method of claim 15, wherein the information is provided remotely using an interactive voice response system (IVR).

18. An improved system for exchanging remote data in a wireless telecommunication system, comprising:
a component for updating a database with first data collected remotely, the first data comprising information corresponding to the availability of a system operator; and
a component for operating the wireless telecommunication system using the database.

19. The system of claim 18, wherein the first data is collected remotely from a system operator.

20. The system of claim 18, wherein the first data is collected using an interactive voice response system (IVR).

21. The system of claim 18, wherein the component for operating the wireless telecommunication system is further configured for assigning trouble tickets to the system operator if the first data indicates that the system operator is available.

22. The system of claim 18, wherein the component for operating the wireless telecommunication system is further configured for notifying a law enforcement agency if a site on the wireless telecommunication system has been entered without the database indicating that the system operator has intentions to enter the site.

23. The system of claim 18, wherein the component for operating the wireless telecommunication system is further configured for compiling statistical information relevant to the availability of the system operator.

24. The system of claim 18, further comprising maintaining records in the database including records corresponding to at least one of the system operator and a site located in the wireless telecommunication system.

25. The system of claim 24, wherein records corresponding to the system operator include whether the system operator is authorized to operate in the wireless telecommunication system.

26. The system of claim 24, wherein records corresponding to the site located in wireless telecommunication system include whether the site is a valid site in the wireless telecommunication system.

27. The system of claim 18, further comprising a component for updating the database with second data collected remotely, the second data comprising information corresponding to the system operator's intention to enter a site.

28. The system of claim 27, wherein the second data is collected remotely from the system operator.

29. The system of claim 27, wherein the second data is collected remotely using an interactive voice response system (IVR).

30. The system of claim 27, wherein the second data comprises a code number for the site.

31. The system of claim 27, wherein the second data is provided to a network operations center (NOC).

32. The system of claim 18, further comprising a component for providing information remotely, the information corresponding to at least one of directions to a site in the wireless telecommunication system and a combination to a lock located on the site in the wireless telecommunication system.

33. The system of claim 32, wherein the information is provided remotely to the system operator.

34. The system of claim 32, wherein the information is provided remotely using an interactive voice response system (IVR).

35. A computer-readable medium on which is stored a set of instructions for exchanging remote data in a wireless telecommunication system, which when executed perform stages comprising:
updating a database with first data collected remotely, the first data comprising information corresponding to the availability of a system operator; and
operating the wireless telecommunication system using the database.

36. The computer-readable medium of claim 35, wherein the first data is collected remotely from a system operator.

37. The computer-readable medium of claim 35, wherein the first data is collected using an interactive voice response system (IVR).

38. The computer-readable medium of claim 35, wherein operating the wireless telecommunication system further comprises assigning trouble tickets to the system operator if the first data indicates that the system operator is available.

39. The computer-readable medium of claim 35, wherein operating the wireless telecommunication system further comprises notifying a law enforcement agency if a site on the wireless telecommunication system has been entered without the database indicating that the system operator has intentions to enter the site.

40. The computer-readable medium of claim 35, wherein operating the wireless telecommunication system further comprises compiling statistical information relevant to the availability of the system operator.

41. The computer-readable medium of claim 35, further comprising maintaining records in the database including records corresponding to at least one of the system operator and a site located in the wireless telecommunication system.

42. The computer-readable medium of claim 41, wherein records corresponding to the system operator include whether the system operator is authorized to operate in the wireless telecommunication system.

43. The computer-readable medium of claim 41, wherein records corresponding to the site located in wireless telecommunication system include whether the site is a valid site in the wireless telecommunication system.

44. The computer-readable medium of claim 35, further comprising updating the database with second data collected remotely, the second data comprising information corresponding to the system operator's intention to enter a site.

45. The computer-readable medium of claim 44, wherein the second data is collected remotely from the system operator.

46. The computer-readable medium of claim 44, wherein the second data is collected remotely using an interactive voice response system (IVR).

47. The computer-readable medium of claim 44, wherein the second data comprises a code number for the site.

48. The computer-readable medium of claim 44, wherein the second data is provided to a network operations center (NOC).

49. The computer-readable medium of claim 35, further comprising providing information remotely, the information corresponding to at least one of directions to a site in the wireless telecommunication system and a combination to a lock located on the site in the wireless telecommunication system.

50. The computer-readable medium of claim 49, wherein the information is provided remotely to the system operator.

51. The computer-readable medium of claim 49, wherein the information is provided remotely using an interactive voice response system (IVR).
